(19) United States
(12) Patent Application Publication
(10) Pub. No.: US 2010/0248555 A1
(43) Pub. Date: Sep. 30, 2010

(54) ELECTRONIC DEVICE ASSEMBLY AND CONNECTOR ASSEMBLY

(75) Inventors: XIAO-FENG MA, Shenzhen City (CN); ZHENG-HENG SUN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD, Shenzhen City (CN); HON HAI PRECISION INDUSTRY CO., LTD., Tu-Cheng (TW)

(21) Appl. No.: 12/430,129

(22) Filed: Apr. 27, 2009

(30) Foreign Application Priority Data
Mar. 30, 2009 (CN) 200910301220.7

(51) Int. Cl. H01R 13/502

(52) U.S. Cl. 439/701; 439/502

(57) ABSTRACT

A connector assembly includes a first connector and a second connector. The second connector includes first and second sub-connectors. The first sub-connector includes a first sidewall on which a locking portion is formed. The second sub-connector includes a second sidewall on which a receiving portion is formed to engagably receiving the locking portion thereby combining the first and second sub-connectors together.

### BACKGROUND

1. Technical Field

The present disclosure relates to electronic device assemblies and connector assemblies and, particularly, to an electronic device assembly and a connector assembly capable of being conveniently assembled to or disassembled from the electronic device assembly.

2. Description of Related Art

Electronic connectors, such as serial advanced technology attachment (ATA) connectors are generally used for connecting electronic devices with peripheral devices, such as disk drives and other peripheral storage devices, to supply power for the peripheral devices. Due to integrated configuration of the electronic connectors, disassembly of the electronic connector is impossible, causing inconvenience. For example, when using an electronic connector in a computer system, a great through hole must be defined in the computer system, for the electronic connector passing therethrough to connect a peripheral device, which easily causes leakage of electromagnetic waves.

### BRIEF DESCRIPTION OF THE DRAWINGS

FIGS. 1 and 2 are exploded, isometric views of an exemplary embodiment of a connector assembly, viewed from different perspectives.

FIG. 3 is an assembled, isometric view of the connector assembly of FIG. 1.

FIG. 4 is an exploded, isometric view of an exemplary embodiment of an electronic device assembly.

### DETAILED DESCRIPTION

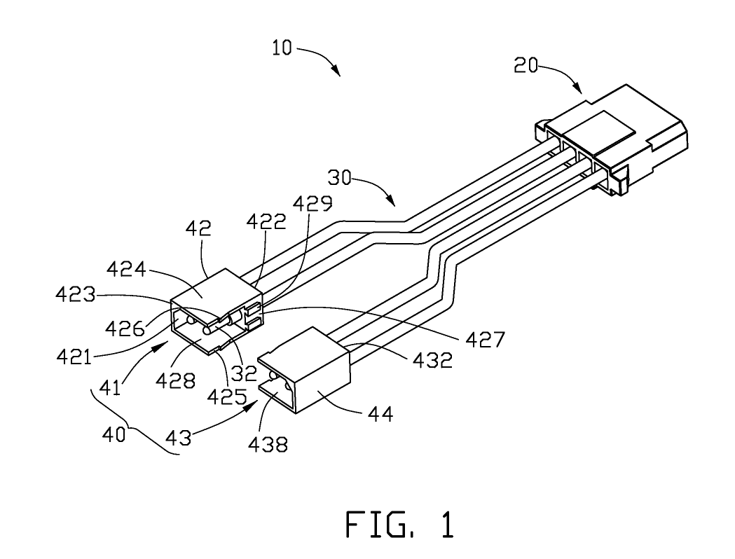

Referring to FIGS. 1 to 4, an exemplary embodiment of an electronic device assembly 500 includes a first electronic device 400 such as a computer system, a second electronic device 404 such as a hard disk, a compact disk drive, or other kind of peripheral device, and a connector assembly 10. The connector assembly 10 includes a first connector 20, a second connector 40, and a plurality of wires 30 connected between the first connector 20 and the second connector 40. The first connector 20 is to connect to a power supply 410 of the first electronic device 400. The second connector 40 is to connect to the second electronic device 404. The second connector 40 includes a first sub-connector 41 and a second sub-connector 43. The first electronic device 400 defines a through hole 402.

The first sub-connector 41 includes a rectangular main body 42 small enough to pass through the through hole 402 of the first electronic device 400. The main body 42 includes a top wall 424, a bottom wall 425, a front wall 423 perpendicularly connected between front ends of the top and bottom walls 424, 425, a back wall 422 perpendicularly connected between rear ends of the top and bottom walls 424, 425, and first and second sidewalls 427, 421 perpendicularly connected between corresponding sides of the top and bottom walls 424, 425. A first receiving space 428 is defined in the main body 42, through the front wall 423 and the first sidewall 427 of the main body 42, to receive a plurality of first electronic plugs 32 of the plurality of wires 30. Two of the wires 30 pass through the back wall 422 to connect to two first electronic plugs 32. Locking portions, such as two protrusions 429, are formed on the first sidewall 427, adjacent to the back wall 422. The protrusions 429 have dovetail-shaped cross-sections. Two wedge-shaped block portions 426 are formed on side surfaces connected to the first sidewall 427 of the top wall 424 and the bottom wall 425, opposite to the protrusions 429. The block portions 426 have triangular-shaped cross-sections.

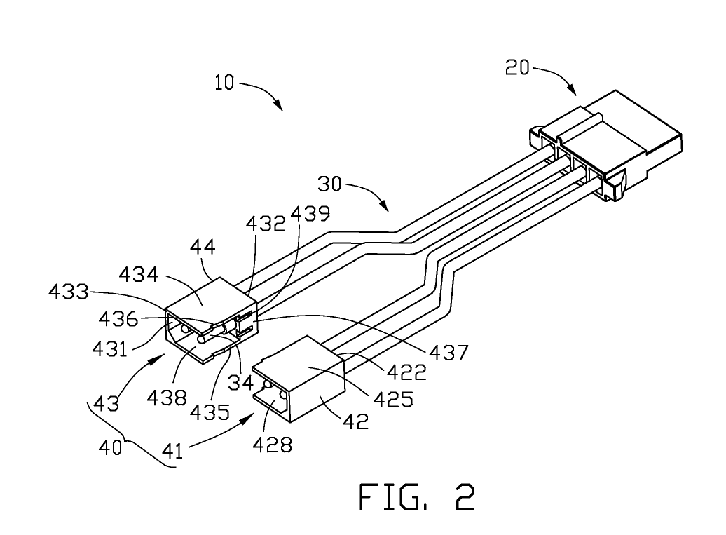

Referring to FIG. 2, the second sub-connector 43 includes a rectangular main body 44 small enough to pass through the through hole 402 of the first electronic device 400. The main body 44 includes a top wall 434, a bottom wall 435, a front wall 433 perpendicularly connected between front ends of the top and bottom walls 434, 435, a back wall 432 perpendicularly connected between rear ends of the top and bottom walls 434, 435, and first and second sidewalls 437, 431 perpendicularly connected between corresponding sides of the top and bottom walls 434, 425. A second receiving space 438 is defined in the main body 44, through the front wall 433 and the first sidewall 437 of the main body 44, to receive a plurality of second electronic plugs 34 of the plurality of wires 30. The remaining wires 30 pass through the back wall 432 to connect to two second electronic plugs 34. Receiving portions, such as two slots 439, are defined in the first sidewall 437, adjacent to the back wall 432 to engagably receive the protrusions 429 of the first sub-connector 41. The slots 439 have dovetail-shaped cross-sections. Two receiving recesses 436 are defined in side surfaces connected to the first sidewall 437 of the top wall 434 and the bottom wall 435, opposite to the slots 439. The receiving recesses 436 have triangular-shaped cross-sections. In other embodiments, the receiving recesses 436 and the block portions 426 are not limited to having triangular-shaped cross-sections, the protrusions 429 and the slots 439 are not limited to having dovetail-shaped cross-sections.

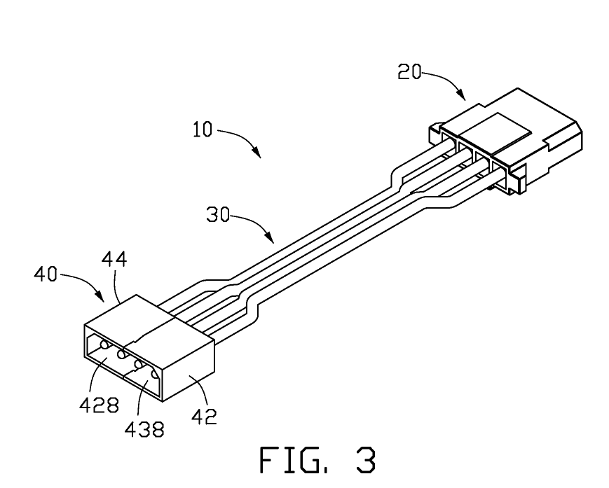

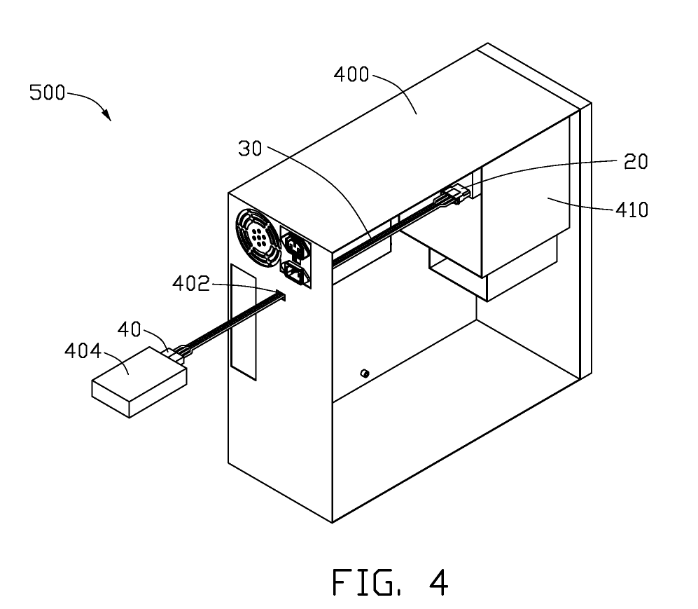

Referring to FIGS. 3 and 4, in assembly, the first connector 20 is inserted into a connector of the power supply 410 of the first electronic device 400. Then the first and second sub-connectors 41, 43 are passed through the through hole 402 of the first electronic device 400 one at a time, then assembled together. In this way the through hole 402 needs only be large enough for one of the sub-connectors to pass through. The sub-connectors 41, 43 are assembled as follows. The protrusions 429 of the first sub-connector 41 are aligned with the slots 439 of the second sub-connector 43, and the block portions 426 of the first sub-connector 41 are aligned with the receiving recesses 436 of the second sub-connector 43. The first and second sub-connector 41, 43 are moved relative to each other, causing the protrusions 429 to be snappingly engaged in the slots 439 and the block portions 426 to be engaged in the receiving recesses 436. The block portions 426 and the protrusions 429 of the first sub-connector 41 prevent the first sub-connector 41 from disengaging from the second sub-connector 43. The first sub-connector 41 is combined with the second sub-connector 43 to form the second connector 40 for connecting to the second electrical device 404.

Because the through hole 402 is only big enough to allow the sub-connectors 41, 43 to pass through one at a time, leakage of electromagnetic wave is prevented or greatly reduced. If a smaller through hole 402 is needed, the second connector 40 can be configured with three or more sub-connectors, thus allowing smaller sub-connectors and so a smaller through hole. The structure of each sub-connector is similar to structure of the first and second sub-connectors 41, 43.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A connector assembly comprising:
a first connector; and
a second connector comprising:
a first sub-connector comprising a first main body, wherein the first main body comprising a first sidewall on which a locking portion is formed; and
a second sub-connector comprising a second main body, wherein the second main body comprising a second sidewall on which a receiving portion is formed to engagably receiving the locking portion thereby combining the first and second sub-connectors together.

2. The connector assembly of claim 1, wherein the locking portion is a protrusion, the receiving portion is a slot.

3. The connector assembly of claim 2, wherein the first main body of the first sub-connector further comprises a top wall and a bottom wall respectively connected to a top and a bottom of the first sidewall, a block portion is formed on a side surface connected to the first sidewall of each of the top and bottom walls; wherein the second main body of the second sub-connector further comprises a top wall and a bottom wall respectively connected to a top and a bottom of the second sidewall, a receiving recess is defined in a side surface connected to the second sidewall of each of the top wall and the bottom wall of the second sub-connector; wherein the block portion is engagable in the corresponding receiving recess.

4. The connector assembly of claim 3, wherein the block portion and the receiving recess have triangular-shaped cross-sections respectively.

5. The connector assembly of claim 1, wherein the main bodies of the first and second sub-connectors are rectangular-shaped.

6. The connector assembly of claim 1, wherein the locking portion and the receiving portion have dovetail-shaped cross-sections, respectively.

7. An electronic device assembly comprising:
a first electronic device comprising a power supply, wherein the first electronic device defining a through hole;
a second electronic device; and
a connector assembly comprising:
a first connector connected to the power supply of the first electronic device; and
a second connector structured to be disassembled into first and second sub-connectors for passing through the through hole of the first electronic device one at a time, the first and second sub-connectors being structured to be combined together outside of the first electronic device to connect to the second electronic device.

8. The electronic device assembly of claim 7, wherein the first sub-connector comprises a first sidewall on which at least one locking portion is formed; and wherein the second sub-connector comprises a second sidewall in which at least one receiving portion is defined, each of the at least one receiving portion engagably receives a corresponding one of the at least one locking portion, thereby combining the first and second sub-connectors together.

9. The electronic device assembly of claim 7, wherein the first electronic device is a computer system.

10. The electronic device assembly of claim 7, wherein the second electronic device is a hard disk.

11. The electronic device assembly of claim 7, wherein the second electronic device is a compact disk drive.

12. An electronic device assembly comprising:
a first electronic device defining a through hole;
a second electronic device; and
a connector assembly comprising:
a first connector connected to the first electronic device and located in the first electronic device; and
a second connector structured to be disassembled into a plurality of sub-connectors each capable of passing through the through hole of the first electronic device, the plurality of sub-connectors being capable of being assembled together to connect to the second electronic device.

13. The electronic device assembly of claim 12, wherein the first electronic device is a computer system.

14. The electronic device assembly of claim 12, wherein the second electronic device is a hard disk.

15. The electronic device assembly of claim 12, wherein the second electronic device is a compact disk drive.
